(19) United States
(12) Patent Application Publication
(10) Pub. No.: US 2025/0349928 A1
(43) Pub. Date: Nov. 13, 2025

(54) COOLING PLATE ASSEMBLY OF BATTERY PACK CASE AND METHOD OF MANUFACTURING SAME

(71) Applicants: HYUNDAI MOTOR COMPANY, SEOUL (KR); KIA CORPORATION, SEOUL (KR)

(72) Inventors: Byong-So Kim, Hwaseong-si (KR); Jae-Hyung Lee, Hwaseong-si (KR)

(73) Assignees: HYUNDAI MOTOR COMPANY, SEOUL (KR); KIA CORPORATION, SEOUL (KR)

(21) Appl. No.: 18/910,769

(22) Filed: Oct. 9, 2024

(30) Foreign Application Priority Data
May 13, 2024 (KR) 10-2024-0062602

(51) Int. Cl. H01M 10/6554; B23K 1/00; B23K 1/20; B32B 15/01; H01M 10/613; H01M 10/625; H01M 50/242

(52) U.S. Cl. CPC H01M 10/6554; B23K 1/0016; B23K 1/203; B32B 15/016; H01M 10/613; H01M 10/625; H01M 50/242; B32B 2457/10; H01M 2220/20

(57) ABSTRACT

A cooling plate assembly of a battery pack case includes a middle plate, a cooling plate bonded to a lower surface of the middle plate, and a plurality of collision reinforcements which are bonded to an upper surface of the middle plate and include a center member and a cross member, wherein the middle plate, the cooling plate, and the collision reinforcements are integrally braze-bonded. A structural stability of the battery pack case can be sufficiently secured, an assembly process can be dramatically simplified, and a manufacturing defective rate can also be innovatively reduced so that quality control can be very easily performed.

### CROSS REFERENCE TO RELATED APPLICATIONS

This application claims priority to Korean Patent Application No. 10-2024-0062602, filed on May 13, 2024, which is incorporated herein by reference in its entirety.

### BACKGROUND

### Field of Present Disclosure

Exemplary embodiments of the present disclosure relate to a cooling plate assembly of a battery pack case and a method of manufacturing the same.

### Description of Related Art

FIG. 1 shows a structure of a battery pack case. The structure of the battery pack case is formed by manufacturing a cooling plate using a brazing method after press manufacturing of a middle plate 121 and a cooling plate 122 which are a cooling system.

In addition, an outer frame 110 including a side member 113 and a collision reinforcement frame including a cross member 111 and a center member 112 in an inner side of the outer frame 110 are manufactured as separate products using an aluminum extrusion method.

Next, the internal collision reinforcement frame is assembled with the cooling plate using a structural adhesive, friction stir welding, melt welding, and the like, the outer frame 110 is assembled with a sub assembly, and then a lower end protector 131 and a cover 132 are mounted on a low case assembly of a battery pack to manufacture the battery pack case.

In the case of conventional battery pack cases manufactured in this manner, the number of extrusion shapes for each sub-part is large, and thus the number of extrusion dies and processing tools required is inevitably large. In addition, the assembly process is very complicated so that the manufacturing man-hours and tooling required for assembly are large, and the manufacturing cycle time is excessively long.

In addition, as lots of welding points occur, the number of cases of welding defects and dimensional dissatisfaction due to product deformation increases, and thus a defective rate also increases.

The contents described in the above Description of Related Art are to aid understanding of the background of the present disclosure and may include what is not previously known to those skilled in the art to which the present disclosure pertains.

### SUMMARY

An embodiment of the present disclosure is directed to providing a cooling plate assembly of a battery pack case that can sufficiently secure structural stability of a battery pack case, drastically reduce an assembly process, and innovatively reduce a defective rate of manufacturing to easily achieve quality control, and a method of manufacturing the same.

Other objects and advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

In accordance with an embodiment of the present disclosure, there is provided a cooling plate assembly of a battery pack case, which includes a middle plate, a cooling plate bonded to a lower surface of the middle plate, and a plurality of collision reinforcements which are bonded to an upper surface of the middle plate and include a center member and a cross member, wherein the middle plate, the cooling plate, and the collision reinforcements are integrally braze-bonded.

Here, the collision reinforcement may be made of a multilayer aluminum material.

In addition, the collision reinforcement may include an inter layer made of a 3000 series aluminum material, a core layer made of a 6000 series aluminum material and stacked on the inter layer, and an upper layer made of a 3000 series aluminum material and stacked on the core layer.

In addition, the collision reinforcement may further include a clad layer made of a 4000 series aluminum material, and the inter layer may be stacked on the clad layer.

Furthermore, based on 100 wt %, the collision reinforcement may include the clad layer of 8±1 wt %, the inter layer 6±1 wt %, the clad layer 80±5 wt %, and the upper layer of 6±1 wt %.

Meanwhile, the middle plate may be made of a 3000 series aluminum material, and the cooling plate may be made such that clads of 3000 series aluminum and 4000 series aluminum are stacked.

In addition, the collision reinforcement may further include an internal reinforcement in a shape of a bent plate in an inside of the collision reinforcement, and the internal reinforcement may be made of an aluminum material containing Mg of 0.3 wt % or less based on 100 wt %.

Furthermore, tensile strength of the collision reinforcement may be 200 MPa or more, and yield strength thereof may be 100 MPa or more.

In addition, a separation force between the collision reinforcement and the middle plate may be 40,000 KN or more.

Alternatively, the collision reinforcement may be made of a 6000 series aluminum material containing Mg of 0.3 wt % or less based on 100 wt %.

In accordance with another embodiment of the present disclosure, there is provided a manufacturing a cooling plate assembly of a battery pack case, which includes manufacturing a plurality of collision reinforcements including a center member and a cross member, manufacturing a cooling plate including a middle plate and a cooling path, applying flux to the collision reinforcement and the cooling plate, assembling the middle plate, the cooling plate, and the collision reinforcements, and integrally brazing the middle plate, the cooling plate, and the collision reinforcements.

In addition, the brazing operation may be performed at an atmospheric temperature ranging from 655° C. to 670° C. under atmospheric nitrogen N₂ for 720 to 900 seconds.

### BRIEF DESCRIPTION OF THE FIGURES

FIG. 1 is a diagram illustrating a structure of a battery pack case.

FIG. 2 is a diagram illustrating each component of a cooling plate of the battery pack case manufactured according to the present disclosure.

FIG. 3 is a diagram illustrating a structure of the cooling plate of the battery pack case manufactured by a manufacturing system according to the present disclosure.

FIG. 4 is a diagram illustrating a configuration of a collision reinforcement of the present disclosure.

FIG. 5 is a diagram illustrating a cross-section of a prototype to which the collision reinforcement of FIG. 4 is applied.

FIG. 6 is a diagram illustrating a relationship between the collision reinforcement and the cooling plate of the present disclosure.

FIG. 7 is a diagram showing a test section for bonding surface analysis of a cooling plate assembly manufactured according to the present disclosure.

FIG. 8 is a diagram illustrating an evaluation of a separation force of a bonded portion of the cooling plate assembly manufactured by the present disclosure.

### DETAILED DESCRIPTION

In order to fully understand the present disclosure and operational advantages of the present disclosure and objects attained by practicing the present disclosure, reference should be made to the accompanying drawings that illustrate exemplary embodiments of the present disclosure and to the description in the accompanying drawings.

In describing exemplary embodiments of the present disclosure, known technologies or repeated descriptions may be reduced or omitted to avoid unnecessarily obscuring the gist of the present disclosure.

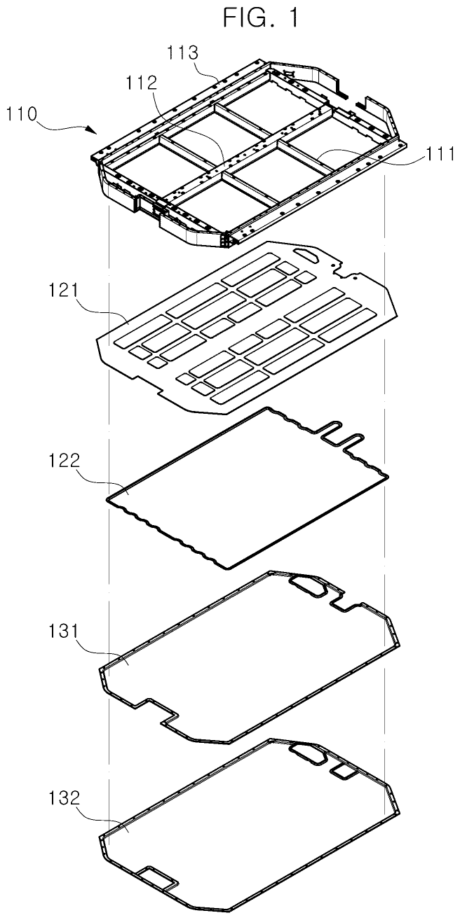

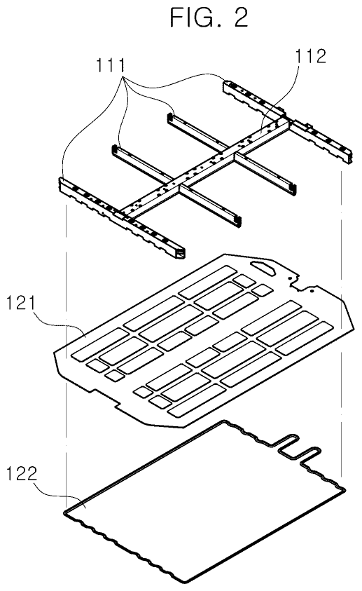

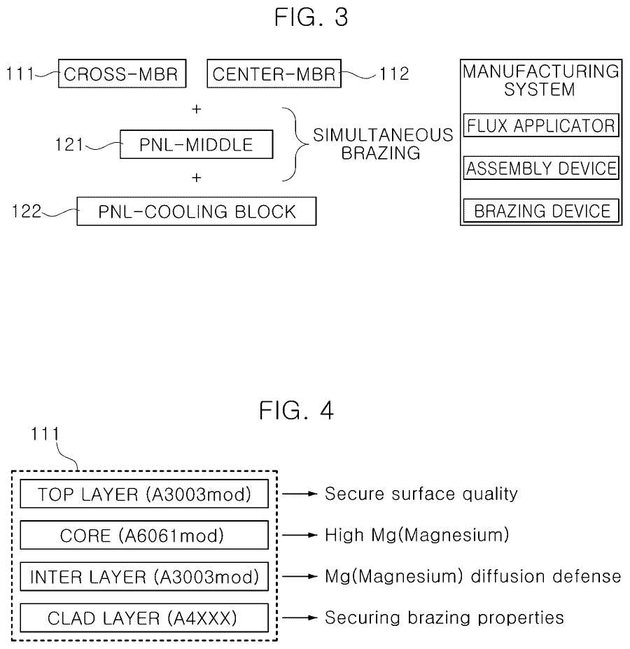

FIG. 1 is a diagram illustrating a structure of a battery pack case. FIG. 2 is a diagram illustrating each component of a cooling plate of the battery pack case manufactured according to the present disclosure, and FIG. 3 is a diagram illustrating a structure of the cooling plate of the battery pack case manufactured according to the present disclosure.

Hereinafter, a cooling plate assembly of the battery pack case and a method of manufacturing the same according to one embodiment of the present disclosure will be described with reference to FIGS. 1 to 3.

The present invention is a cooling system that constitutes a battery pack case with a structure shown in FIG. 1 and is a method of manufacturing an integrated structure by simultaneously bonding a cooling plate including a middle plate 121 and a cooling plate 122 shown in FIG. 2 to a collision reinforcement, which is conventionally assembled by bonding or welding, through continuous furnace brazing.

First, the collision reinforcement is manufactured.

The collision reinforcement may include a plurality of cross members 111 whose length direction is a transverse direction of a vehicle body and a center member 112 whose length direction is a longitudinal direction of the vehicle body.

The collision reinforcement is made of a high-strength multilayer aluminum material, and unlike conventional extruded materials, the collision reinforcement is manufactured by bending and pressing a plate material.

Then, a middle plate 121 and a cooling plate 122 including a cooling path are prepared.

Here, the middle plate 121 may be made of a 3000 series aluminum, and the cooling plate 122 may be formed by stacking clads of 3000 series aluminum and 4000 series aluminum.

Next, flux is applied to a clad surface of the collision reinforcement and the cooling plate 122 by a flux applicator. This is because it is necessary for a general continuous furnace brazing process to secure productivity.

Then, the middle plate 121, the cooling plate 122, and the collision reinforcement are assembled by an assembly device, and then an integrated cooling plate assembly is manufactured through a brazing process.

That is, as shown in FIG. 3, the middle plate 121, the cooling plate 122, the cross members 111 and the center member 112 as the collision reinforcement are brazed simultaneously by a brazing device.

In this case, an atmospheric temperature of a brazing furnace under atmospheric nitrogen N₂ is set to a maximum temperature ranging from 655° C. to 670° C., and brazing is performed for 720 to 900 seconds.

In this way, after manufacturing the integrated cooling plate assembly, a side member 113 is welded using friction stir welding, and a protector 131 and a cover 132 are assembled to manufacture the battery pack case.

Next, referring to FIGS. 4 to 6, the collision reinforcement made of a high-strength multilayer aluminum material has a multilayer structure in which an inter layer is stacked on a clad layer, a core layer is stacked on the inter layer, and a top layer is stacked on the core layer. More specifically, the clad layer of 8 wt %±1 wt % based on 100 wt % is intended to protect brazing properties of 4000 series aluminum with a composition Al-11Si-1.0Fe.

In addition, the inter layer of 6 wt %±1 wt % may be made of 3000 series aluminum with a composition of Al01.5Mn to prevent diffusion, and the core layer of 80 wt %+5 wt % may be made of 6000 series aluminum containing high manganese of Al-1.0Si-0.5Mg.

In addition, the upper layer of 6 wt %±1 wt % is made of 3000 series aluminum with a composition of Al-1.5Mn and provided to protect a surface.

Through such a configuration, the collision reinforcement has characteristics of tensile strength of 200 MPa or more and yield strength of 100 MPa or more.

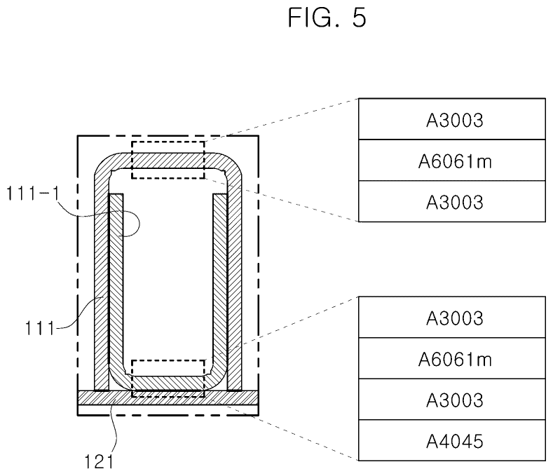

In addition, as shown in FIG. 5, the collision reinforcement may be formed into a bent shape or inlet shape (u) by bending the plate, and an internal reinforcement 111-2 may be brazed and bonded to an inside of the collision reinforcement. Alternatively, an additional rib may be formed in the inside, and it is preferred that the internal reinforcement 111-2 is made of an aluminum material containing Mg of 0.3 wt % or less.

A necessary hole may be additionally processed in the collision reinforcement using laser processing.

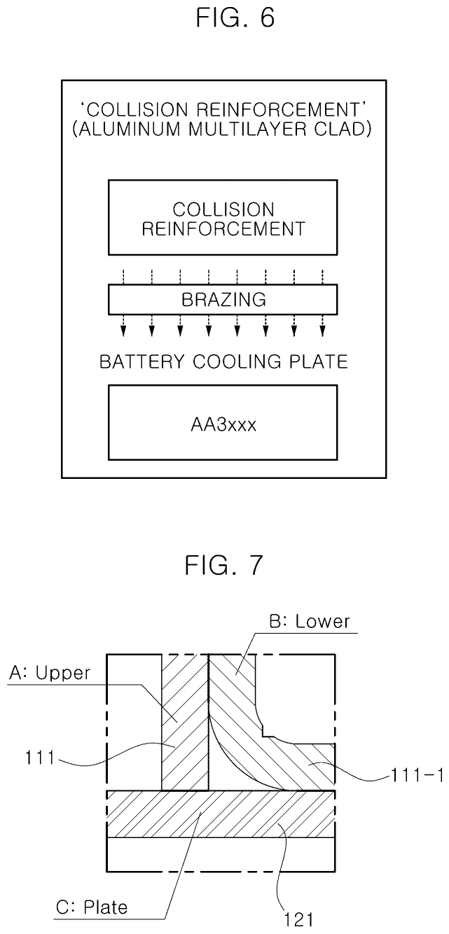

As shown in FIG. 6, the collision reinforcement including the aluminum multilayer clad is bonded to the cooling plate by one-shot brazing.

When an extruded material is applied, Mg of 0.3 wt % or less may be contain in a 6000 series aluminum base, and the extruded material is manufactured separately, and then the collision reinforcement may be brazed as an integrated shape.

Next, a prototype shown in FIG. 5 was manufactured to test performance of the cooling plate.

The brazing bonded surface of the collision reinforcement was analyzed through a microscope by cutting a cross section, and the brazing bonded surface was analyzed through computerized tomography (CT) imaging.

It was confirmed that the brazing bonded surface in all portions A, B, and C of FIG. 7 satisfied the International Standards Organization (ISO) quality standards.

In addition, welding of brazing and the existing product was compared through evaluation of a separation force using a universal tensile test machine, and the welding of brazing and the existing product was compared through a squeezing test of the collision reinforcement using a compression and tensile tester.

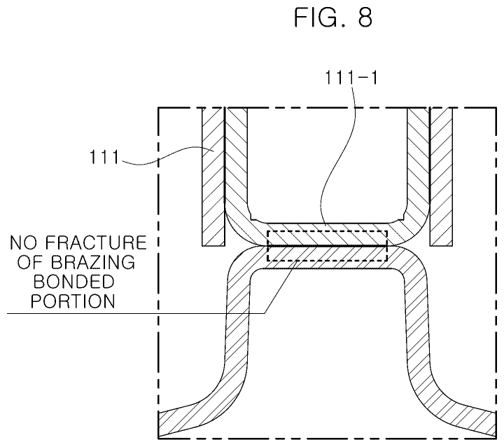

As a result of the test in which an average load of 44,473 N was applied to the prototype of the present disclosure, it was confirmed that no fracture occurred in a brazing bonded portion as shown in FIG. 8. In the case of the existing separate post-process welding, a fracture occurred in the brazing bonded portion as a result of a test in which an average load of 34.155 N was applied. Therefore, it was confirmed that the separation force between the cooling plate and the collision reinforcement according to the present disclosure was 40,000 KN or more.

This is because, in the case of welding (magnetic impulse generator (MIG) and a laser) after manufacturing the existing separate product extrusion material, the separate product is line-welded to the cooling plate, but in the case of the present disclosure, face to face brazing bonding is possible so that bonding strength is more excellent.

Furthermore, in the squeezing test, it was confirmed that the welded portion of 90% or more of the brazed integrally developed product of the present disclosure was maintained within a deformation region, whereas, in the case of the existing separate welded product, fracture spread from the unwelded portion, and thus the welded portion within the deformation region was entirely fractured.

As described above, according to the present disclosure, it is possible to reduce production costs and cycle time through simplification of the battery pack case assembly welding process and secure rigidity of the battery pack case through a collision reinforcement structure (longitudinal/transverse members) and the face to face brazing bonding structure of the cooling plate. In addition, when welding is performed after manufacturing the existing reinforcement structure as a separate product, the cooling plate bonding can only be done by line-welding, but in the case of the brazing integrated type, surface-bonding is possible so that a separation force of 30% can be additionally secured.

In accordance with the present disclosure, reduction of production cost and cycle time is possible through simplification of s battery pack case assembly welding process.

In addition, rigidity of a battery pack case can be secured through a collision reinforcement structure (longitudinal/transverse members) and a surface brazing bonding structure of a cooling plate.

In addition, when welding is performed after manufacturing a separate product with the existing reinforcement structure, cooling plate bonding can only be done by line-welding, but in the case of a brazing integrated type, surface-bonding is possible so that a separation force of 30% can be additionally secured.

When machining holes required for module mounting after manufacturing the separate product with the existing reinforcement structure, individual processing is required according to a location, but according to the present disclosure, a cost of assembly hole processing can be reduced when a battery module is mounted.

In addition, in the case of an present multilayer clad material, since a plate material is manufactured through bending, the multilayer clad material can be manufactured through a single punching process per sheet.

While the present disclosure has been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

1. A cooling plate assembly of a battery pack case, comprising:
a middle plate;
a cooling plate bonded to a lower surface of the middle plate; and
a plurality of collision reinforcements which are bonded to an upper surface of the middle plate and include a center member and a cross member;
wherein the middle plate, the cooling plate, and the plurality of collision reinforcements are integrally braze-bonded.

2. The cooling plate assembly of claim 1, wherein each of the plurality of collision reinforcements is made of a multilayer aluminum material.

3. The cooling plate assembly of claim 2, wherein each of the plurality of collision reinforcements includes:
an inter layer made of a 3000 series aluminum material;
a core layer made of a 6000 series aluminum material and stacked on the inter layer; and
an upper layer made of a 3000 series aluminum material and stacked on the core layer.

4. The cooling plate assembly of claim 3, wherein:
each of the plurality of collision reinforcements further includes a clad layer made of a 4000 series aluminum material; and
the inter layer is stacked on the clad layer.

5. The cooling plate assembly of claim 4, wherein, based on 100 wt %, each of the plurality of collision reinforcements includes the clad layer of 8±1 wt %, the inter layer 6±1 wt %, the clad layer 80±5 wt %, and the upper layer of 6±1 wt %.

6. The cooling plate assembly of claim 4, wherein:
the middle plate is made of a 3000 series aluminum material; and
the cooling plate is made such that clads of 3000 series aluminum and 4000 series aluminum are stacked.

7. The cooling plate assembly of claim 2, wherein:
each of the plurality of collision reinforcements further includes an internal reinforcement in a shape of a bent plate in an inside of each collision reinforcement; and
the internal reinforcement is made of an aluminum material containing Mg of 0.3 wt % or less based on 100 wt %.

8. The cooling plate assembly of claim 2, wherein tensile strength of each of the plurality of collision reinforcements is 200 MPa or more, and yield strength thereof is 100 MPa or more.

9. The cooling plate assembly of claim 8, wherein a separation force between each collision reinforcement and the middle plate is 40,000 KN or more.

10. The cooling plate assembly of claim 1, wherein each of the plurality of collision reinforcements is made of a 6000 series aluminum material containing Mg of 0.3 wt % or less based on 100 wt %.

11. A method of manufacturing a cooling plate assembly of a battery pack case, the method comprising:
manufacturing a plurality of collision reinforcements including a center member and a cross member;
manufacturing a cooling plate including a middle plate and a cooling path;
applying flux to the plurality of collision reinforcements and the cooling plate by a flux applicator;
assembling the middle plate, the cooling plate, and the plurality of collision reinforcements by an assembly device; and
integrally brazing the middle plate, the cooling plate, and the plurality of collision reinforcements by a brazing device.

12. The method of claim 11, wherein brazing is performed at an atmospheric temperature ranging from 655° C. to 670° C. under atmospheric nitrogen N₂ for 720 to 900 seconds.

13. The method of claim 11, wherein each of the plurality of collision reinforcements is made of a multilayer aluminum material.

14. The method of claim 13, wherein each of the plurality of collision reinforcements includes:
a clad layer made of a 4000 series aluminum material;
an inter layer made of a 3000 series aluminum material and stacked on the clad layer;
a core layer made of a 6000 series aluminum material and stacked on the inter layer; and
an upper layer made of a 3000 series aluminum material and stacked on the core layer.

15. The method of claim 14, wherein, based on 100 wt %, each of the plurality of collision reinforcements includes the clad layer of 8±1 wt %, the inter layer of 6±1 wt %, the clad layer of 80±5 wt %, and the upper layer of 6±1 wt %.

16. The method of claim 13, wherein:
the middle plate is made of a 3000 series aluminum material; and
the cooling plate is made such that 3000 series aluminum and a 4000 series aluminum clad are stacked.

17. The method of claim 11, wherein:
in the manufacturing of the plurality of collision reinforcements, a plate material is bent and pressed to manufacture the plurality of collision reinforcements; and
each of the plurality of collision reinforcements includes an internal reinforcement made of an aluminum material containing Mg of 0.3 wt % or less based on 100 wt % in an inside of each collision reinforcement.
